(19) United States
(12) Patent Application Publication
(10) Pub. No.: US 2010/0097447 A1
(43) Pub. Date: Apr. 22, 2010

(54) Image Display Device

(75) Inventors: Isao Tomisawa, Tsurugashima-shi (JP); Takeshi Furugoori, Tsurugashima-shi (JP); Masaru Ishikawa, Tsurugashima-shi (JP)

Correspondence Address: NIXON & VANDERHYE, PC, 901 NORTH GLEBE ROAD, 11TH FLOOR, ARLINGTON, VA, 22203, US

(73) Assignee: Pioneer Corporation, Tokyo (JP)

(21) Appl. No.: 12/594,089

(22) PCT Filed: Mar. 30, 2007
(86) PCT No.: PCT/JP2007/057167

§ 371 Date: Sep. 30, 2009

(51) Int. Cl. H04N 13/04

(52) U.S. Cl. 348/51; 348/E13.075

(57) ABSTRACT

It is an object to provide an image display device that does not damage a feeling of a three-dimensional shape of an object displayed as a floating image even if a contrast of a display unit is so bad that floating blacks occur. An image display device (100) is comprised of a display unit (10) having an image display surface (11) for displaying a two-dimensional image, an image transmitting panel (20) disposed apart from the image display surface (11), and a floating image display unit (1) that forms an image of light projected from the image display surface (11) on an image forming plane (30) in a space positioned on a reverse side to a side opposite to the display unit (10) of the image transmitting panel (20) to display a floating image. A shielding plate (2) is disposed at a place from the image display surface (11) of the display unit (10) to an observing place. The shielding plate (2) is comprised of a black mask (shielding member) (40) with a rectangular frame, for instance, shaped at the frame portion of the image transmitting panel (20) and shields a part or all of the light projected from a boundary (11a) of a display area of the image display surface (11) of the display unit (10).

### TECHNICAL FIELD OF THE INVENTION

The present invention relates to image display devices for pseudo-stereoscopically displaying two-dimensional images.

### BACKGROUND ART

An image display device, in which an image transfer panel (for example, a microlens array consisting of a plurality of lenses) is placed in front of a two-dimensional image at a predetermined space therefrom, for displaying a pseudo stereoscopic image (floating image) of the two-dimensional image onto a space in front of the image transfer panel has been known (for example, see a first patent document and a second patent document). The image display device is adapted to focus the two-dimensional image by the image transfer panel while floating the two-dimensional image, thus displaying the two-dimensional image as if to display a three-dimensional image.

First patent document: Japanese Patent Laid-Open No. 2001-255493

Second patent document: Japanese Patent Laid-Open No. 2003-098479

### DISCLOSURE OF THE INVENTION

### Problems to be Solved by the Invention

When a display unit, such as an LCD, for displaying a two-dimensional image has a low contrast, a phenomenon that a luminance in black slightly increases, that is, “black floating”, arises, causing problems that make it difficult to recognize black as black.

In this case, even if a portion except for an object to be displayed as the two-dimensional image is displayed in black, because light actually leaks from a liquid crystal panel, edges of the display surface are imaged by the image transfer panel. This results in that a rectangular light gray plane with the object is seen, causing floating effect of the object (floating image), that is, stereoscopic effect to be impaired.

Particularly, in the case of the image display device set forth above, the image display device preferably has a high-intensity display unit. The higher in light intensity of the display unit, the more the black floating is highlighted. Moreover, an increase in the contrast of the display unit is technically limited, and a high contrast display unit cannot be always used in cost.

The present invention has been made to solve the aforementioned problems, and has an example of a purpose of providing an image display device that maintains stereoscopic effect of an object to be displayed as a floating image even if a black floating appears due to a display unit having a low contrast.

### Means for Solving the Problems

In order to achieve such a purpose provided above, an image display device recited in claim 1 includes a display unit having an image screen for displaying a two-dimensional image; and an image transfer panel located far from the image screen, and includes a floating image display means that focuses light left from the image screen on an imaging plane in a space to thereby display a floating image, the space being located on one side of the image transfer panel opposite to the other side thereof facing the display unit; and a shielding means that is located at any position from the image screen of the display unit to a viewing point and that shields at least a portion of light left from a boundary of a display area of the image screen.

An image display device recited in claim 10 includes a display unit having an image screen for displaying a two-dimensional image; and an image transfer panel located far from the image screen, and includes a floating image display means that focuses light left from the image screen on an imaging plane in a space to thereby display a floating image, the space being located on one side of the image transfer panel opposite to the other side thereof facing the display unit, characterized in that an active area of a panel surface of the image transfer panel is smaller than a display area of the image screen.

### BRIEF DESCRIPTION OF THE DRAWINGS

FIG. 1 is an outline perspective view of an image display device according to an embodiment of the present invention;

(a) of FIG. 2 is a view describing how an image looks in the image display device according to the embodiment of the present invention;

(b) of FIG. 2 is one side view of the image display device according to the embodiment of the present invention;

FIG. 3 is a structural view of an image transfer panel of the image display device according to the embodiment of the present invention;

FIG. 4 is a view describing optical operations of a microlens array that is the image display device according to the embodiment of the present invention;

FIG. 5 is a view describing optical operations of a microlens array having a structure different from that of the microlens array illustrated in FIG. 4;

FIG. 6 is a view describing how an image looks in an image display device with no masks;

FIG. 7 is a view describing optical operations of the image display device according to the embodiment of the present invention;

FIG. 8 is a view illustrating a size of a shielding area of a mask of the image display device according to the embodiment of the present invention;

FIG. 9 is a view illustrating variations of the locations of the mask of the image display device according to the embodiment of the present invention;

FIG. 10 is a view illustrating a modification of the mask of the image display device according to the embodiment of the present invention;

FIG. 11 is a view describing how an image looks when the mask illustrated in FIG. 10 is used; and

FIG. 12 is a view illustrating various shapes of mask of the image display device according to the embodiment of the present invention.

### DESCRIPTION OF CHARACTERS

1 Floating image display unit

2 Shield member

10 Display unit

11 Image screen

11a Edge

20 Image transfer panel

21 Lens array half

22 Transparent substrate

23 Micro convex lens

25 Microlens array

30 Image plane

40, 40A Mask

50 opening

100, 100A Image display device

### BEST MODES FOR CARRYING OUT THE INVENTION

An embodiment of the present invention will be described hereinafter with reference to the drawings.

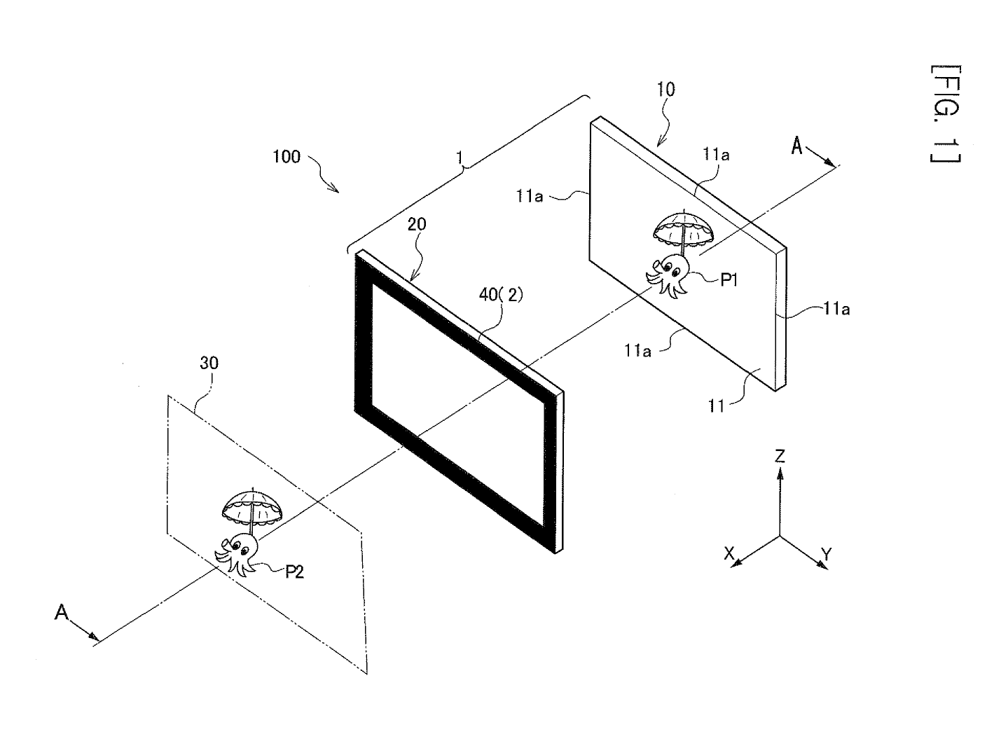

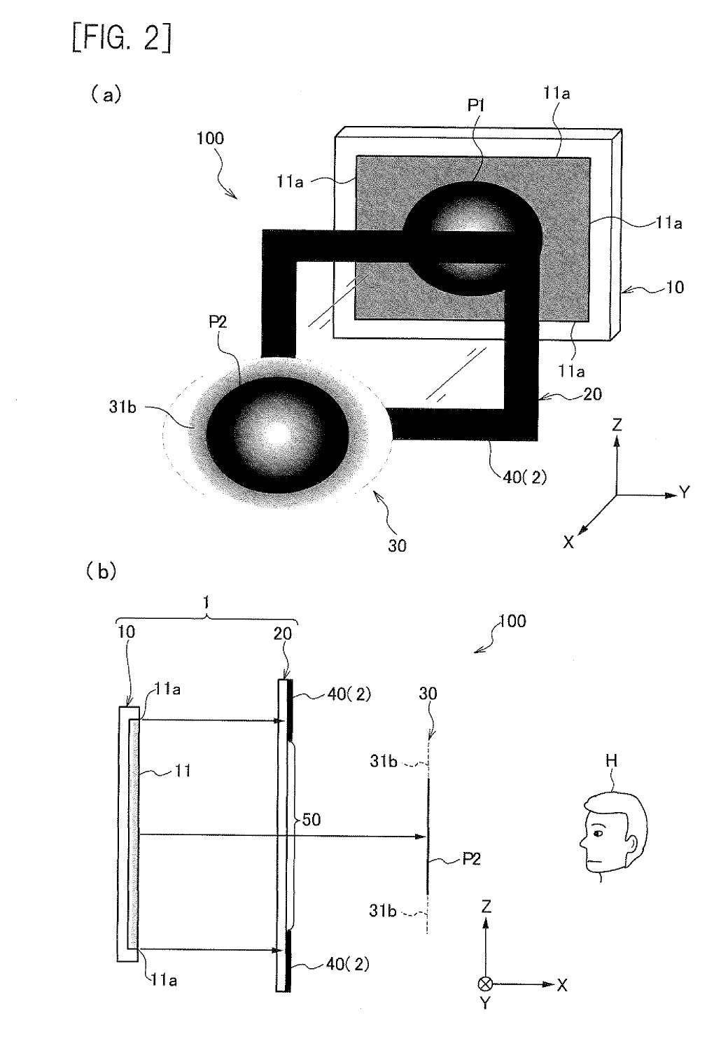

FIGS. 1 and 2 are schematically structural views of an image display device 100 according to an embodiment of the present invention. FIG. 1 is an outline perspective view of the image display device 100, (a) of FIG. 2 is a view describing how an image looks, and (b) of FIG. 2 is a cross sectional view of the image display device 100 as viewed from its lateral direction (A-A direction of FIG. 1).

The image display device 100 is a pseudo stereoscopic-image display device for displaying, on a preset plane in a space, a two-dimensional image that is visibly recognizable by a viewer H. The image display device 100 is provided with a floating image display unit 1 for displaying a floating image (a two-dimensional image to be displayed on a preset plane in a space), and a shield member 2 for shielding, when a floating image is displayed, the boundaries of a screen of the display unit so that the viewer H cannot recognize the boundaries.

The floating image display unit 1 is made up of a display unit 10, and an image transfer panel 20 located to be spaced from the display unit 10. The display unit 10 is equipped with an image screen 11 for displaying two-dimensional images, and with a display driver (not shown) for drive and control of the display unit 10. The display unit 10 displays, on the image screen 11, an image according to drive signals of the display driver.

Specifically, as the display unit 10, a color liquid crystal display (LCD) can be used, which is provided with a flat screen 11 and a display driver consisting of an illuminating backlighting unit and a color liquid crystal drive circuit. Note that another device except for the LCD, such as an EL (Electro-Luminescence) display, a plasma display, CRT (Cathode Ray Tube), or the like, can be used.

Note that, in the embodiment, in order to describe the characteristics of the image display device 100, the image display device 100 using the display unit 10 having a low contrast that allows the black floating to arise will be described. The image display device 100, of course, can use the display unit 10 having a high contrast that prevents the black floating from arising.

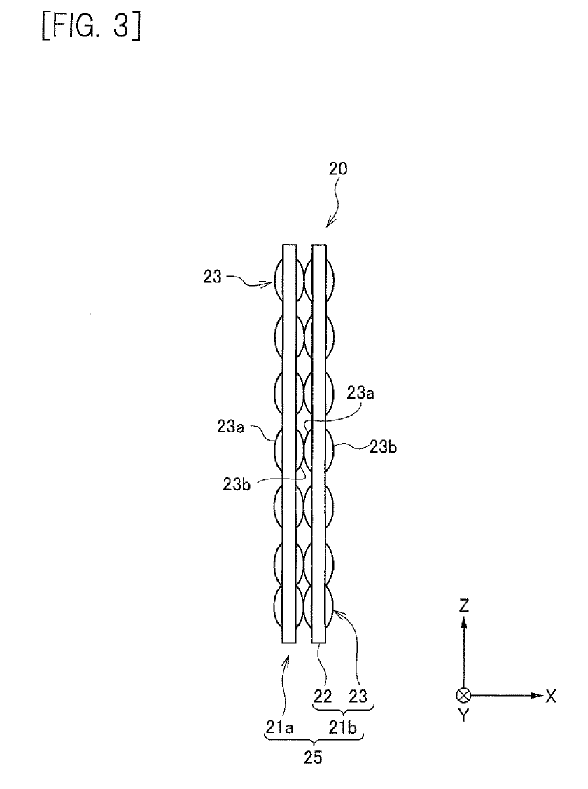

The image transfer panel 20 includes, for example, a microlens array 25 with a panel screen arranged in substantially parallel to the image screen 11 of the display unit 10. The microlens array 25, as illustrated in FIG. 3, is configured such that two lens array halves 21a, 21b are arranged in parallel to each other. Each of the lens array halves 21a, 21b is designed such that a plurality of micro convex lenses 23 are two-dimensionally arranged to be adjacent to each other on either surface of a transparent substrate 22 made from high translucent glass or resin; the micro convex lenses 23 have the same radius of curvature.

An optical axis of each of the micro convex lenses 23a formed on one surface is adjusted such that the adjusted optical axis is aligned with the optical axis of a corresponding micro convex lens 23b formed at an opposing position on the other surface. Specifically, individual pairs of the micro convex lenses 23a, 23b adjusted to have the same optical axis are two-dimensionally arranged such that their respective optical axes are parallel to each other.

The microlens array 25 is placed in parallel to the image screen 11 of the display unit 10 at a position far therefrom by a predetermined distance (a working distance of the microlens array 25). The microlens array 25 is adapted to focus light, corresponding to an image and left from the image screen 11 of the display unit 10, on an image plane 30 on the side opposite to the image screen 11 and far therefrom at the predetermined distance (working distance of the microlens array 25). This displays the image displayed on the image screen 11 on the image plane 30 as a two-dimensional plane in a space.

The formed image is a two-dimensional image, but is displayed to float in the space when the image has depth or the background image on the display is black with its contrast being enhanced. For this reason, the viewer H looks the formed image as if it is floated. Note that the image plane 30 is a virtually set image in the space and not a real object, and one plane defined in the space according to the working distance of the microlens array 25.

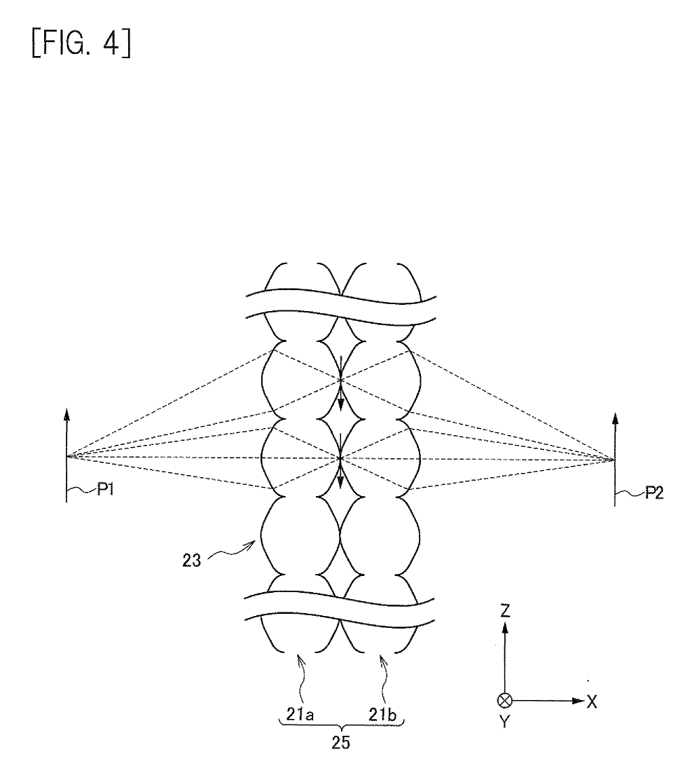

The microlens array 25, as illustrated in FIG. 4, is adjusted to be arranged such that:

light corresponding to an image P1 and left from the image screen 11 of the display unit 10 is incident from the lens array half 21a, flipped thereinside at one time, flipped again, and thereafter, outputted from the lens array half 25b.

This allows the microlens array 25 to display the two-dimensional image P1 displayed on the image screen 11 of the display unit 10 as an erected floating image P2 on the image plane 30.

More specifically, in the light forming the two-dimensional image P1 to be displayed on an image screen 11a, light of an image in a region corresponding to each of the micro convex lenses 23 of the microlens array 25 is captured by each of the micro convex lenses 23, flipped in each of the micro convex lenses 23, flipped again, and outputted so that the floating image P2 is displayed as a set of erected images formed by the respective micro convex lenses 23.

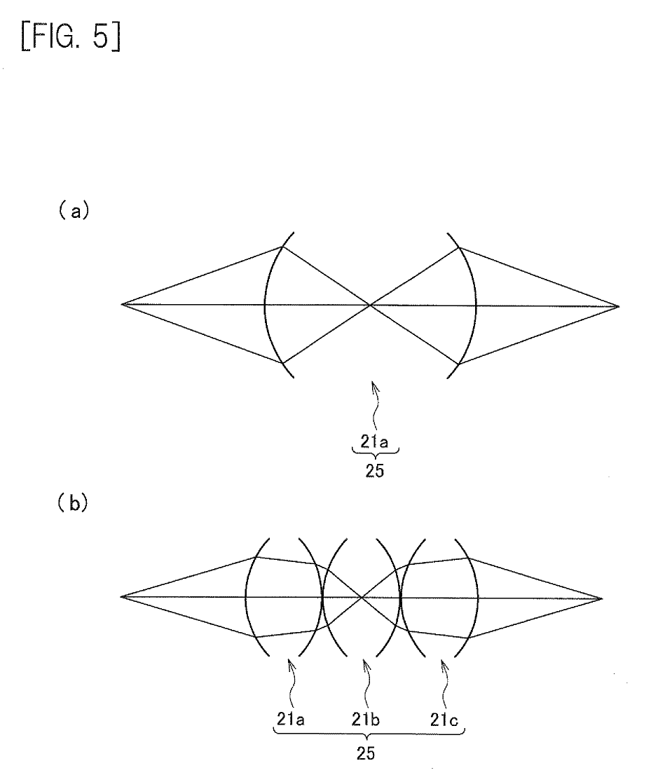

Note that the microlens array 25 is not limited to the structure of a pair of two lens array halves 21a, 21b, and can be configured by a single lens array, or by a plurality of lens arrays equal to or greater than three lens arrays. Of course, when a floating image is formed by odd-numbered, such as one or three, lens array halves 21, referring to (a) and (b) of FIG. 5, light incident to the micro lens array 25 is flipped at one time therein, and flipped again. For this reason, it is possible to display an erected floating image. As described above, various configurations of the microlens array 25 can be made. These configurations allow the working distance for forming light to have a constant effective range without limiting the single working distance.

Note that, in the embodiment, the image transfer panel 20 is the microlens array 25, but not limited thereto, and can be any member for forming erected images, desirably erected equal-magnification images, such as other forms of lenses, or mirrors or prisms; these mirrors or prisms form erected equal-magnification images. For example, a gradient index lens array, a GRIN lens array, a rod lens array, or the like can be a microlens array, and a roof mirror array, a corner mirror array, a dove prism or the like can be a micromirror array. One Fresnel lens having a required active area, which forms a reverted image, can be used in place of arrays.

The shield member 2, as one example, referring to FIG. 1, is constructed by a black mask (shield) 40 formed on the edge portion of the image transfer panel 20 in the form of the letter “ [symbol] ”, which shields some or all of the light left by the boundaries (edges) 11a of the display area of the image screen 11 of the display unit 10. For this reason, the viewer H does not recognize floating images of the edges 11a on the image plane 30, and can monitor only the floating image P2 of the object P1.

Note that the sentence “the viewer H dose not recognize floating images of the edges 11a on the image plane 30” can mean that the viewer H cannot recognize, as the viewer's feeling, floating images of the edges 11a on the image plane 30, and does not always mean the complete shield of the light outputted from the edges 11a (of course, may mean the complete shield of the light outputted from the edges 11a). Note that the mask 40 is preferably colored in black or dark tone.

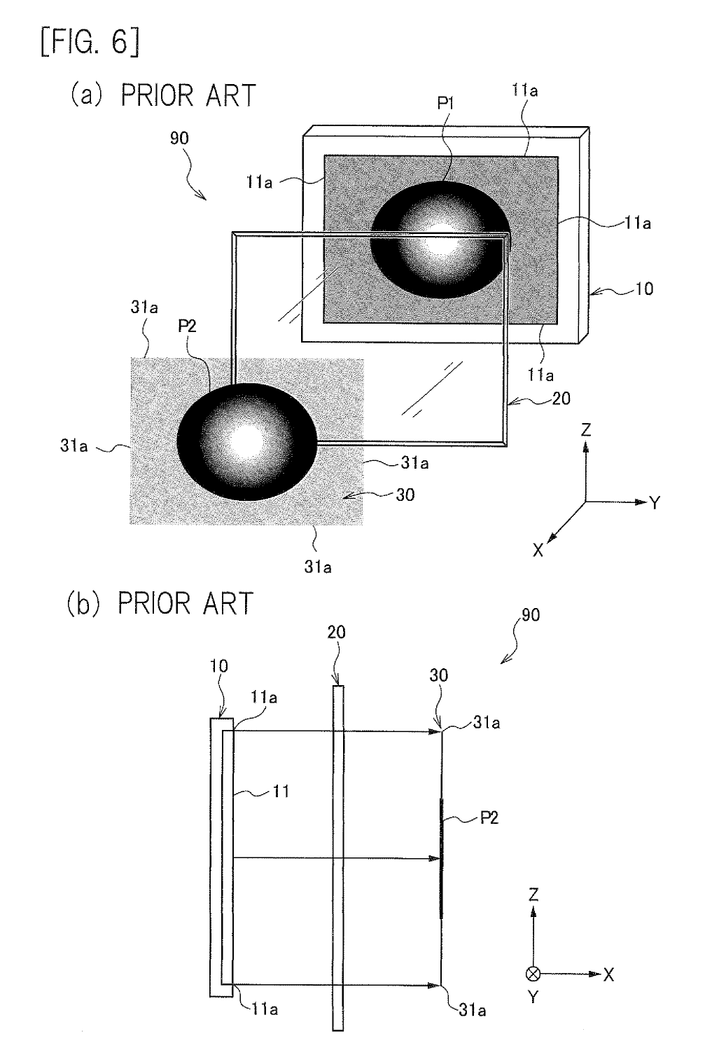

FIG. 6 is a structural view of a conventional image display device 90 that does not include the shield member 2 and uses the display unit 10 having a low contrast that allows the black floating to arise. (a) of FIG. 6 is an outline perspective view of the image display device 90, and (b) of FIG. 6 is one side view of the image display device 90. The image display device 90, as illustrated in (a) and (b) of FIG. 6, displays the edges 11a in addition to the object P1 on the image plane 30 as a floating image, and therefore, the viewer H recognizes edges 31a in the floating image.

This results in that the viewer H feels the edges 31a as a rectangular plane on the image plane 30, making it difficult to recognize the floating image P2 of the object P1 as a three-dimensional object. Specifically, when the display unit 10 having a low contrast that allows the black floating to arise is provided, the black parts in an image (the parts from which no light is inherently left) are displayed in gray. For this reason, the viewer H recognizes the edges 31a focused by gray light of the edges 11a as a gray image, resulting in that the entire display area of the image screen 11 is recognized on the image plane 30 as a rectangular gray plane.

In contrast, with the image display device 100 according to the embodiment, as illustrated in FIG. 2, because some or all of the light of the edges 11a of the image screen 11 are shielded by the mask 40, the viewer H cannot recognize a floating image of the edges 11a.

Specifically, gray light of the display area inside the edges 11a is focused on the image plane 30 (a gray floating image 31b), but because of the mask 40, the amount of light on the image plane 30 is attenuated with close to the edges 11a of the image screen 11 so that the gray floating image 31b is gradually paled out from its center to its edges. For this reason, the viewer H cannot recognize the edges 31a of the image plane 30. When the edges 31a on the image plane 30 cannot be recognized, a rectangular gray plane cannot be recognized. Thus, the viewer H can recognize only the floating image P2 of the object P1, and therefore, can stereoscopically look the floating image P2.

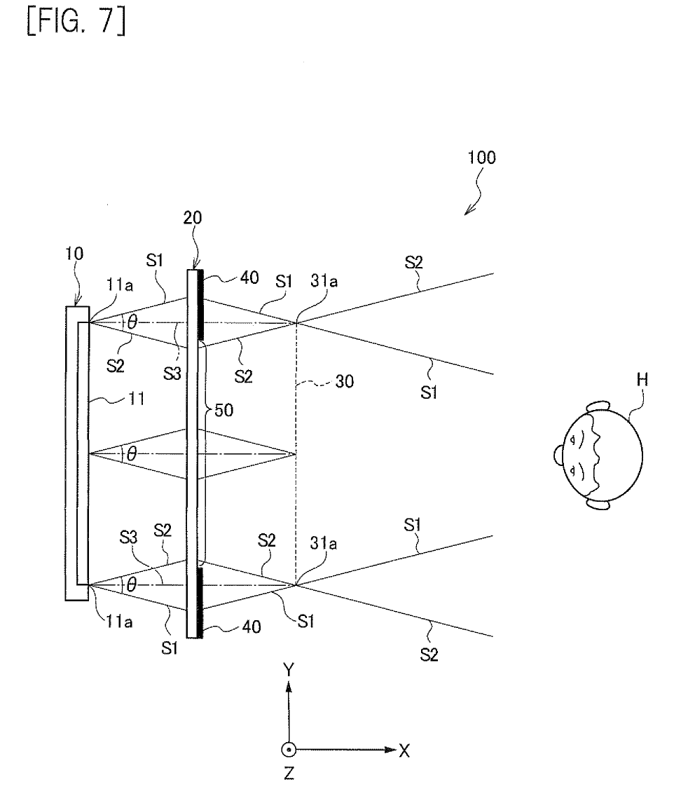

FIG. 7 is a view describing the size of the shielding area of the mask 40 with reference to an angular field of view of the image transfer panel for focusing light left from the image screen 11 of the display unit 10. Note that the angular field of view of the image transfer panel for focusing light left from the image screen 11 of the display unit 10 is represented as θ, light left outermost from the edges 11a is represented as S1, light left innermost from the edges 11a is represented as S2, and a main light beam left from the edges 11a is represented as S3. In addition, note that the mask 40 is mounted on the image transfer panel 20, and the viewer H is located at the center of the image screen 11 of the display unit 10.

FIG. 7 shows a case where an area of an opening 50 defined by the mask 40 is set to be smaller than the display area of the image screen 11 (the center of the opening 50 and that of the image screen 11 coincide with each other). In this case, the mask 40 is able to shield: light between the light S1 left from the edges 11a and the main light beam S3; and light left slightly inside the main light beam S3.

Specifically, in all of the light left from the edges 11a, the mask 40 does not shield the light that travels outwardly (precisely, shield some thereof) in the image plane 30, and shields the light that travels inwardly (to the center) in the image plane 30. For this reason, when the viewer H performs the monitoring at the same point without moving, the viewer H does not recognize the floating image 31a of the edges.

As described above, when the area of the opening 50 defined by the mask 40 is set to be smaller than the display area of the image screen 11, in all of the light left from the edges 11a, the light travelling inwardly (to the center) in the image plane 30 can be shielded, and, because the light travelling outwardly in the image plane does not reach the eyes of the viewer H, the viewer H does not recognize the edges 31a.

Note that, if the viewer H moved from the center of the image screen 11, the viewer H would look the light travelling outwardly. In this case, because more than half the light left from the edges 11a are shielded, the amount of light is low, and the edges 31a are not clearly recognized.

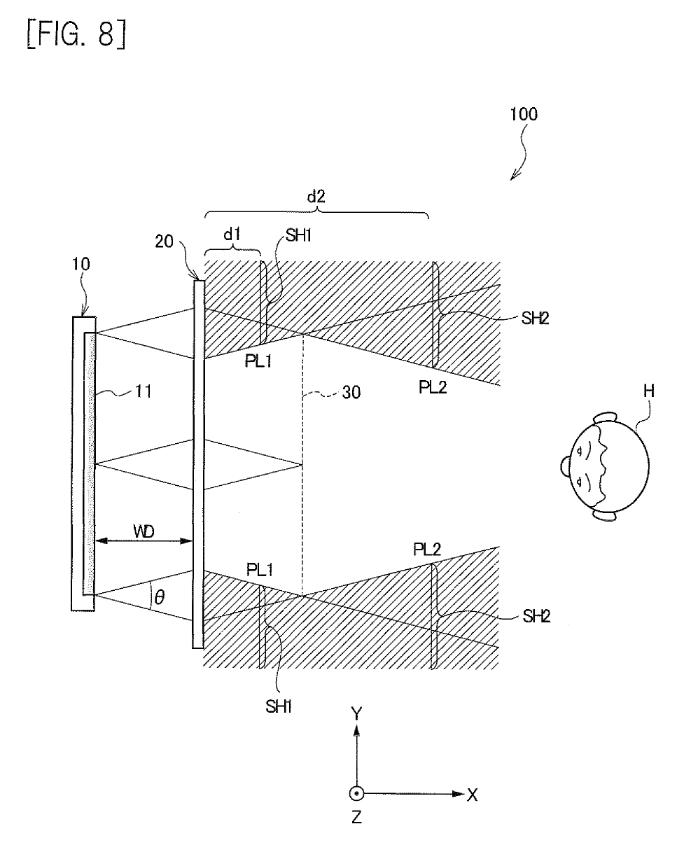

FIG. 8 is a view illustrating the size of the shielding area of the mask 40 for shielding all of the light left from the edges 11a. Specifically, FIG. 8 illustrates, when all of the light left from the edges 11a are shielded, how much shielding area is needed for which positions to mask. The hatched areas illustrated in FIG. 8 represent the shielding area of the mask 40. For example, when the masking is carried out at a position PL1 far from the image transfer panel 20 by a distance d1 on the viewer H side, the shielding area of the mask 40 is SH1.

Moreover, when the masking is carried out at a position PL2 far from the image transfer panel 20 by a distance d2 on the viewer side, the shielding area of the mask 40 is SH2. In this case, all of the light left from the edges 11a are shielded. For this reason, even if the viewer H moves from the center position, the viewer H does not recognize the floating image 31a of the edges.

The shielding area (hatched area) of the mask 40 that shields all of the light left from the edges 11a is calculated based on the angular field of view θ of the image transfer panel for focusing light left from the image screen 11 of the display unit 10 and the working distance WD. Specifically, the position of the edges 11a on the image screen 11 in addition to the angular field of view θ of the image transfer panel for focusing light left from the image screen 11 of the display unit 10 and the working distance WD allow the shielding area (hatched area) of the mask 40 to be uniquely determined.

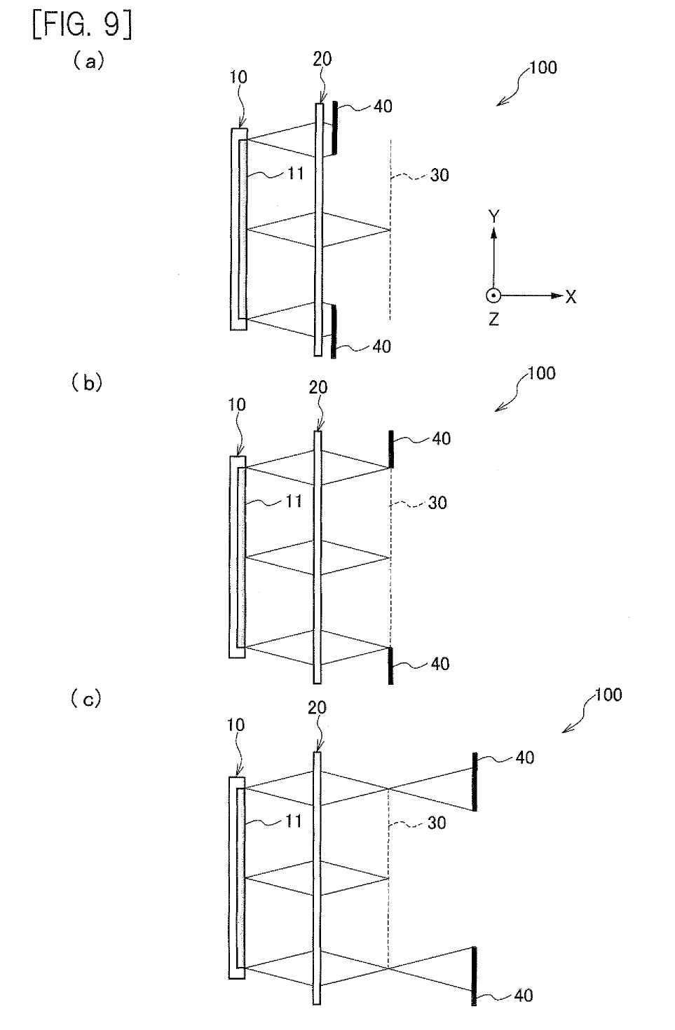

FIG. 9 is a structural view of the image display device 100 specifically illustrating the locations of the mask 40. (a) of FIG. 9 shows a case where the mask 40 is located at the back side of the image plane 30 relative to the viewer H (a direction close to the image transfer panel 20), and (b) of FIG. 9 shows a case where the mask 40 is located close to the image plane 30. (c) of FIG. 9 shows a case where the mask 40 is located at the front side of the image plane 30 relative to the viewer H (a direction far from the image transfer panel 20).

Referring to FIG. 9, when the masking is carried out adjacent to the image plane 30, the shielding area of the mask 40 is the smallest. In contrast, when the masking is carried out at the front side of the image plane 30, the farer the mask is from the image plane 30, the larger the shielding area of the mask 40 is (the narrower the display area of the floating image is) and the greater the size of a housing (not shown) of the image display device 100 is. For this reason, this is less preferred.

Thus, it is preferable that, in the image display device 100, the mask 40 is located at the back side of the image plane 30. Moreover, considering that the shielding can be naturally carried out without the viewer H concerning the presence of the mask 40, it is more preferable that the mask 40 is mounted on the image transfer panel 20.

Note that, in the locations of the mask 40 illustrated in FIG. 9, it has been only described that the masks 40 are for example located at the front side of the image transfer panel 20 relative to the viewer H, but the mask 40 can be located at the back side of the image transfer panel 20 relative to the viewer H, that is, the mask 40 can be located between the image screen 11 of the display unit 10 and the image transfer panel 20. In this case, as the location of the mask 40 approaches the display unit 10, the edges of the mask 40 may be focused on the imaging surface 30 by the image transfer panel 20, resulting in that the viewer H may recognize the imaging surface 30, and therefore, it is undesirable that the mask 40 is located adjacent to the display unit 10.

As described above, the image display device 100 according to the embodiment is equipped with the display unit 10 having the image screen 11 for displaying two-dimensional images and with the image transfer panel 20 located far from the image screen 11. The image display device 100 includes:

floating image displaying means 1 for focusing light left from the image screen 11 on an image plane 30 in a space located across the image transfer panel 20 from a display portion 11 to thereby display a floating image; and

a shield member 2 located at any position from the display unit 10 to a viewing position and shielding at least some of light left from boundaries 11a of the display area of the image screen 11.

This prevents, even if the display unit 10 has a low contrast that allows the black floating to arise, recognition of the focus of the light left from the edges 11a of the image screen 11, thus maintaining stereoscopic effect of an object to be displayed on the image plane 30 as the floating image.

For example, when the area of the opening 50 formed by the mask 40 is smaller in size than the display area of the image screen 11, it is possible to shield light travelling inwardly (to the center) in the image plane 30 in all of the light left from the edges 11a of the image screen 11. For this reason, the viewer H does not recognize a floating image of edges when viewing from the front direction.

In some cases, the area of the opening 50 formed by the mask 40 may be larger in size than the display area of the image screen 11. Even if the area of the opening 50 formed by the mask 40 may be larger in size than the display area of the image screen 11, there are no problems by, for example, shielding some of the light left from the edges 11a to attenuate the amount of focused light.

Realistically, the size of the area on which floating images are to be displayed is changed depending on the size of the shielding area of the mask 40. For this reason, an optimum shielding area of the mask 40 is determined from applications of the image display device 100, the size of floating images, the location and movement of a viewer, the level of the black floating, and the like.

The embodiment and examples of the present invention have been described, but they can be subjected to various modifications and deformations.

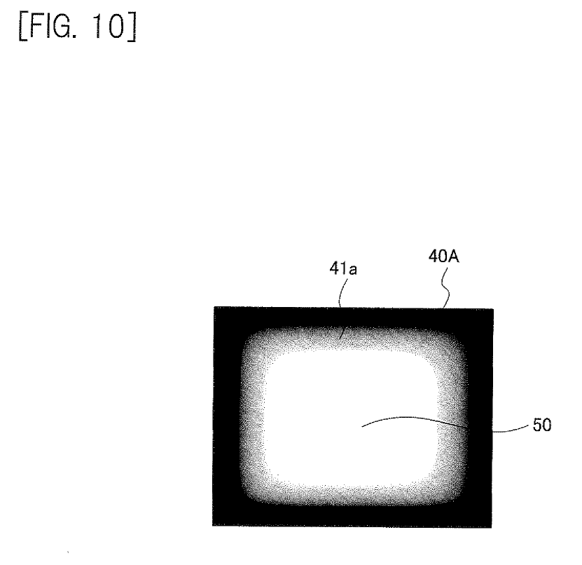

For example, the mask can have gradations to naturally blur image formations of edges. FIG. 10 illustrates a mask 40A gradated in color from light to dark from its center (opening 50) to its outsides, in other words, the mask 40A formed such that light transmission is gradually reduced from its center to its outsides. The mask 40A can more naturally blur the floating image 31a of the edges 11a.

In particular, when the mask is mounted on the image screen 11 or located adjacent thereto, it is preferable to apply the mask 40A. In this application, as described above, because the edges 41a of the mask 40 are focused on the image plane 30, using the mask 40A subjected to the gradations can naturally blur a floating image of the edges 41a of the mask 40.

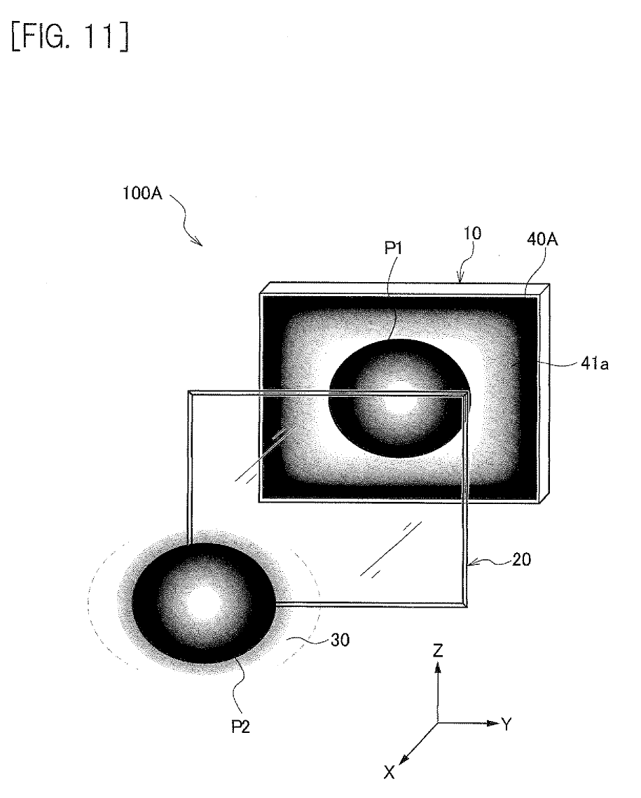

FIG. 11 illustrates the structure of an image display device 100A when the mask 40A is mounted on the image screen 11 of the display unit 10, and a floating image that the image display device 100A displays. Referring to FIG. 11, the floating image of the edges 41a of the mask 40A is displayed to be blurred by the mask 40A subjected to the gradations, and therefore, the viewer H can recognize the floating image P2 of the object P1 as a stereoscopic image without concerning edges of the mask 40A.

As described above, with the image display device 100A with the mask 40A subjected to the gradations, it is possible to more naturally blur image formation of edges of the mask 40A even if the mask 40A is located between the display unit 10 and the image transfer panel 20, especially on the image screen of the display unit 10). For this reason, stereoscopic effect of an object to be displayed on the image plane 30 as a floating image is maintained.

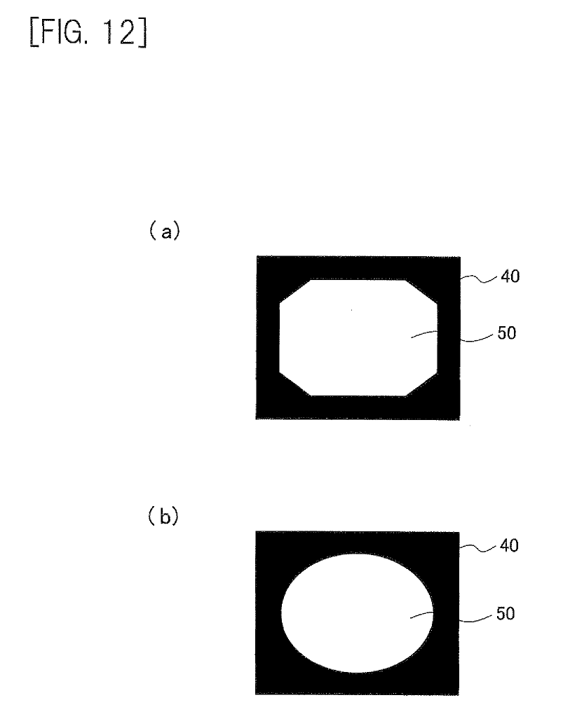

Moreover, in the embodiment, the masks 40 and 40A are in the form of the letter “ [symbol] ” (the opening 50 has a rectangular shape), but the shape of the masks are not limited thereto. The masks 40 and 40A can have various shapes that can shield at least some of the light left from the edges 11a of the image screen 11 of the display unit 10. For example, as illustrated in (a) of FIG. 12, the mask 40 can have the opening 50 with a polygonal shape, such as a hexagonal shape, or as illustrated in (b) of FIG. 12, the mask 40 can have the opening 50 with a circular or elliptical shape.

In the embodiment, the masks 40 and 40A are preferably colored in black or dark tone, but they can be in a cooler similar to a color of the visual appearance of the image display apparatus 100 depending on the design or the like of the visual appearance of the image display device 100 in order to give a unified image of the entire of the image display device 100.

Furthermore, in the embodiment, the masks 40 and 40A are configured to shield portions or all of the light left from the edges 11a of the image screen 11 of the display unit 10, but they are not required when there is a configuration that can shield portions or all of the light left from the edges 11a of the image screen 11 of the display unit 10. For example, the active area of the image transfer panel 20 can be formed in size as the area of the opening 50. Specifically, the active area of the image transfer panel 20 can be formed to be smaller than the display area of the image screen 11 of the display unit 10. In this case, as well as when the mask is mounted, it is possible to shield portions or all of the light left from the edges 11a, and therefore, the viewer H does not recognize the floating image 31a of the edges 11a.

The mask 40 can serve, in addition to the shield member 2, as a member with another function. For example, the mask 40 can serve as a supporting member for fixing and supporting the image transfer panel 20.

1. An image display device comprising:
a display unit having an image screen with a display area, the display unit working to display a two-dimensional image on the display area;
an image transfer panel located far from the image screen and having a panel surface larger than the image screen;
a floating image display means that focuses light left from the image screen on an imaging plane in a space to thereby display a floating image, the space being located across the image transfer panel from the display unit; and
a shielding means that is located at any position from the image screen of the display unit to a viewing point and that shields at least a portion of light left from an edge portion of the display area of the image screen.

2. The image display device according to claim 1, wherein the shielding means comprises:
an opening portion that causes the light left from the image screen to pass therethrough; and
a shielding portion formed around the opening portion and shielding the light left from the edge portion of the display area of the image screen.

3. The image display device according to claim 2, wherein the opening portion has an opening area and the opening area of the opening portion is smaller than the display area of the image screen.

4. The image display device according to claim 2, wherein the opening portion has an opening area with a size, the size of the opening area of the opening portion is determined based on: the position of the shielding means to be located, an angular field of view of the image transfer panel that focuses the light left from the image screen, and a working distance.

5. The image display device according to claim 2, wherein the edge portion of the display area of the image screen is made up of at least first, second, third, and fourth edges, and the shielding means shields at least one of the first, second, third, and fourth edges of the edge portion.

6. The image display device according to claim 2, wherein the shielding portion is formed around the opening portion such that light transmission of the shielding portion is gradually reduced with distance from a center of the opening portion.

7. The image display device according to claim 1, wherein the shielding means is located between the image transfer panel and the imaging plane.

8. The image display device according to claim 7, wherein the shielding means is located on the image transfer panel.

9. The image display device according to claim 2, wherein the shielding means is located between the image screen and the image transfer panel and the shielding portion is formed around the opening portion such that light transmission of the shielding portion is gradually reduced with distance from a center of the opening portion.

10. An image display device comprising:
a display unit having an image screen with a display area, the display unit working to display a two-dimensional image on the display area;
an image transfer panel located far from the image screen; and
comprising a floating image display means that focuses light left from the image screen on an imaging plane in a space to thereby display a floating image, the space being located across the image transfer panel from the display unit,
wherein a panel surface of the image transfer panel is smaller than the image screen, the panel surface of the image transfer panel shielding at least part of light left from an edge portion of the display area of the image screen.

11. The image display device according to claim 1, wherein the light left from the image screen corresponds to the two-dimensional image displayed on the display area of the image screen, and the image transfer panel is a microlens array, the microlens array being arranged such that:
the light left from the image screen is incident thereto, flipped thereinside, flipped again, and thereafter outputted from the microlens array whereby the light outputted from the microlens array is focused on the imaging plane so that an erected equal magnification image is displayed on the image plane as the floating image.

12. The image display device according to claim 1, wherein the image transfer panel has one surface with a substantially rectangular edge opposing the space, and the shielding means has a substantially rectangular ring shape and is mounted on the substantially rectangular edge of the image transfer panel.
